(19) United States
(12) Patent Application Publication
(10) Pub. No.: US 2015/0149313 A1
(43) Pub. Date: May 28, 2015

(54) Method For Providing A Customer With Information At A Point Of Sale (POS)

(71) Applicants: Anna Bacher, Wien (AT); Christian Bacher, Wien (AT); Erich Gstrein, Wien (AT)

(72) Inventors: Anna Bacher, Wien (AT); Christian Bacher, Wien (AT); Erich Gstrein, Wien (AT)

(73) Assignee: SMART ENGINE GmbH, Wien (AT)

(21) Appl. No.: 14/400,326

(22) PCT Filed: May 8, 2012
(86) PCT No.: PCT/AT2012/000129

§ 371 Date: Jan. 28, 2015

(51) Int. Cl. G06Q 20/20; H04W 4/14; G06Q 20/10

(52) U.S. Cl. CPC G06Q 20/20; G06Q 20/102; H04W 4/14; G06Q 20/209
USPC 705/24; 705/16

(57) ABSTRACT

A method for providing a customer with information at a POS, comprising the steps of: identifying the customer at a POS terminal; requesting a bill from a cash register system and sending it together with the identification information to a personalization server; creating and/or supplementing the customer's profile within the personalization server and calculating a personalized information based on the users history as well as provided data by the merchant; sending back the personalized information to the POS terminal; and putting out the personalized information to the customer via an interface.

### RELATED APPLICATIONS

This application is a U.S. National Phase Application under 35 USC 371 of International Application PCT/AT2012/166530 filed May 8, 2012.

### FIELD OF THE INVENTION

The present invention relates to a method for providing a customer with information at a point of sale (POS).

### BACKGROUND OF THE INVENTION

Currently POS terminals are responsible for proofing the validity of a payment card for an initiated payment transaction requested by the connected cashier system. Receiving a request from the cash register the POS terminal checks, by sending the appropriate information (primary account number and amount) to the card issuer bank system, if the given amount can be debited from the account associated with the card swiped. Existing output devices such as printers (in the case of a cash register) or displays are mainly used to show billing relevant information or some un-personalized marketing information.

On the other hand personalization has evolved as major instrument of direct marketing especially in the context of e commerce. Online retailers or subscription service providers build extensive profiles based on the system interactions and purchase behavior of their customers. These profiles are than used to create product recommendations best matching the needs of the customer to be served.

The WO 2006/120350 discloses a benefit management method and system for any type of bank card. A customer's bill is supplemented with an advertising information such as a voucher for another store. Although this is done after an identification process of the customer via its bank card, the advertising information contains static data not fitted to products actually bought.

The WO 2010/047854 teaches a system and methods for delivering targeted marketing offers to consumers via an online portal. Here, a customer's bill is supplemented with advertising information as well. Drawback is, that the information is static and not fitted to personal interests of the customer. Furthermore it depends on printing a bill while there might be other communication channels to put the information to customers.

### SUMMARY OF THE INVENTION

One object of the present invention is to remedy theses disadvantages and to provide a method providing more useful information for the customer in more direct ways than those known hitherto. The method should safe energy consumption of all electronic devices involved.

These and other objects are attained in accordance with one aspect of the invention directed to a method for providing a customer with information at a point of sale (POS), comprising the steps of:

identifying the customer at a POS terminal;
requesting a bill from a cash register system and sending it together with the identification information to a personalization server;
creating and/or supplementing the customer's profile within the personalization server and calculating a personalized information based on the users history as well as provided data by the merchant;
sending back the personalized information to the POS terminal; and putting out the personalized information to the customer via an interface.

In advantageous embodiments the step of putting out the personalized information comprises a display connected with the POS terminal and/or connected with the cash register.

Advantageously, the step of putting out the personalized information uses SMS or e-mail service to a mobile communication system such as a mobile phone.

Again advantageously, the step of putting out the personalized information is done via printing it on the bill of the cash register.

In another advantageous embodiment, the user is identified at the POS terminal by a payment card, a mobile phone or another proper apparatus.

Equally advantageously, the method comprises the step of:

requesting an identification server if the customer's allowance for personalization its information exists.

In advantageous embodiments the data for creating and/or supplementing the customer's profile within the personalization server comprises one or more of: the customer identification, POS terminal identification, date, time, currency, the bill, descriptive information of the demanded products, descriptive information of the customer.

Advantageously, a recommendation engine creates personalized recommendation information based on the data provided.

Again advantageously, the method comprises the step of: sending personalized recommendation information directly to the customer's devices.

In another advantageous embodiment, the method comprises the step of: displaying the personalized information on the display associated with the POS terminal according to the quality or existence of the recommendation.

### BRIEF DESCRIPTION OF THE DRAWINGS

The present invention well be better understood on reading the following description of embodiments given as non-limiting examples.

It refers to the drawings accompanying it in which:

FIG. 1 shows major components used in embodiments of the present invention.

FIG. 2 shows the overall data flow.

FIG. 3 shows the interactions between the major components used in embodiments of the present invention.

FIG. 4 shows the overall process, implemented in a bank system.

### DETAILED DESCRIPTION OF THE DRAWINGS

The present invention enables personalized information collection and delivery, with economies of server power, actions of merchants and customers and others, directly at point of sales also in physical stores by adding new functionality to cash register and POS terminals. Basically, customer profiles are created on the basis of the information provided by the cash register and the POS terminal. This information consist of—but is not limited to—a detailed list of items bought together with price, currency and quantity information, the date and time as well as the location of the purchase and a terminal identification number.

Based on this information customer profiles are created or refined by a profiling module of an associated personalization system. These profiles are than used by a recommender system to generate personalized recommendations based on the data provided. These recommendations can range from personalized product suggestions to user specific adaptations of the bill currently processed.

Personal based changes affecting the currently processed bill are issued to the cash register where they are printed on the cash register printer. Furthermore, personalized recommendations are presented on the POS and/or cash register display and are issued to the cash register printer too. Product recommendations are presented to the customers on the associated display (cash register, POS terminal) only when available or when the prediction quality is sufficient. So these electric devices can be in an energy saving idle mode until some information needs to be displayed.

Furthermore, the personalized filtered information is send from the personalization system to different clients associated with the customer such as, e.g., hand held devices, computers over different channels such as SMS, e-mail, etc.

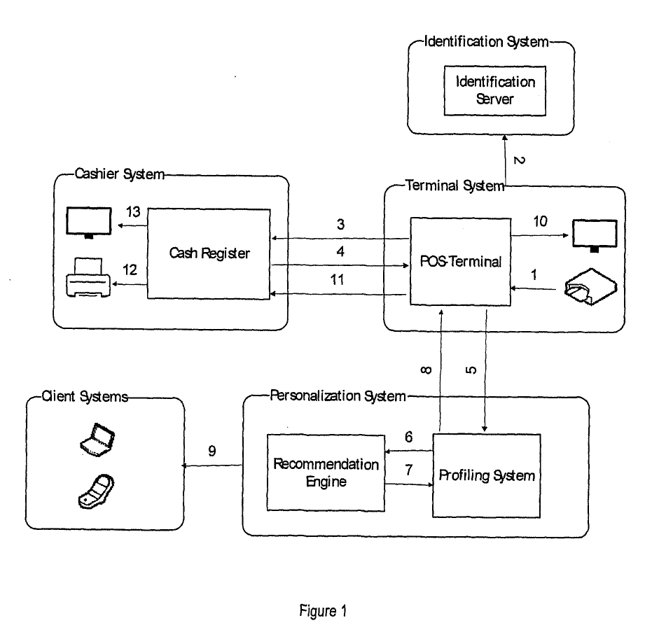

FIG. 1 shows major components used in the present invention. Following a common definition, a POS terminal (point of sale terminal) is an electronic device used to process card payments at retail locations. Basically, a POS terminal uses a magnetic stripe reader and network connection to (i) read the information off a customer's credit or debit card, (ii) check whether the funds in a customer's bank account are sufficient, (iii) transfer the funds from the customer's account to the seller's account and (iv) record the transaction and print a receipt. Point of sale terminals are a combination of software and hardware that allows retail locations to accept card payments without updating their cash registers to read cards directly.

In the context of the present invention, collecting the customer's information is not limited to debit or credit cards only but is also extended to other methods such as electronic identification methods, bio-metric identification, etc. The POS terminal is extended with the following functionality:

I. The POS terminal is extended with the functionality to call an external Identification server to check the allowance for personalization for the given customer identified
II. The POS terminal is extended with the functionality to request a detailed receipt/bill from the cash register
III. The POS terminal is extended with the capability to send the receipt and POS relevant information such as terminal identification, customer identification to a dedicated personalization system.
IV. The POS terminal is extended with the capability to present personalized information on an assigned display.

Following again a common definition, an electronic cash register is a system designed to enable products to be sold at a retail store. Electronic cash registers help large retail outlets track sales, minimize register errors, collect inventory data and much more. An electronic cash register typically processes goods by: (i) reading the information contained on a product label (usually using a scanner), (ii) checking the price database for the price matching the label information, (iii) adding that price to the running total of all products being purchased by the customer, (iv) sending data to sales and inventory software after the sale is complete.

In the context of the present invention, the cash register is extended with the following functionality:

I. The cash register is extended with the functionality to generate a detailed bill information object for the POS terminal. This information consists of—but is not limited to—the following information
a. List of product codes, together with number and price, b. Date and time,
c. Location of the store.
II. The cash register is extended with the capability to print personalized information.
III. The cash register is extended with the functionality to display personalized information on an associated screen.

A personalization system is a software system, which provides services to enable the dynamic insertion, customization or suggestion of content/information in any format that is relevant to the individual user, based on the user's implicit behaviour and preferences, and explicitly given details.

The personalization system on hand consists of at least a pro-filing (sub) system and a recommendation engine.

The profiling system is responsible for creating and refining user profiles, based on the data provided. Typically, a user profile evolves over time and gets more detailed when more information is used. The recommendation engine is a software system which generates recommendations for users based on provided data. If the provided data is personalized, such systems can also generate personalized recommendations. The identification server is a software application or module, which (i) checks the validity of a given personal identification and (ii) proofs, if the person associated has given his/her allowance for being personalized.

In a first step 1 (see FIG. 1), the customer is identified at the point of sales, either by swiping a card through a card reading device or by using another appropriate apparatus such as bio-metric sensors or electronic devices (e.g. with NFC capability) associated with the POS terminal.

Having identified the customer, the POS terminal sends in step 2 this information to an Identification Server for checking, if the customer has given his allowance for being personalized. The Identification Server checks the validity of the received information and proofs if the affirmation of the associated user is. present. This information, or an appropriate error code in case when the validation fails, is returned to the POS terminal.

If the allowance of the customer exists, the POS terminal requests in step 3 the detailed bill information from the cash register system. Receiving the bill request from the POS terminal the cash register system creates a detailed bill information, comprising (i) a detailed list of product codes or names together with number and price information, (ii) the total sum and currency of the bill, (iii) the date and time, (iv) the location of the store. This information is returned in step 4 to the POS terminal.

Having got the detailed bill information from the cash register, the POS terminal sends in step 5 this bill information together with terminal relevant information such as, e.g., terminal identification code, terminal time, terminal location, etc. to an associated personalization server.

The personalization server uses the data to create and/or refine the customers profile and to generate personalized information, such as a proposal or recommendations in step 6 and 7. The data received from the POS terminal is passed to a profiling system where it is used to create and/or refine customer profiles. Based on these profiles, together with provided background information concerning products and customers, personalized recommendations are generated by the recommendation engine.

Once having defined relevant personalized information the personalization server (i) sends in step 8 this information back to the requesting OS terminal and (ii) sends in step 9 the personalized information direct to the customers preferred devices by using different messaging channels such as SMS or e-mail.

The POS terminal, having received the personalize information from the personalization server, displays this information or proposal—if available—on the associated display (step 10). Furthermore, the POS terminal informs the cash register to adapt the bill according to the provided personalized information (step 11).

The cash system, having received the personalized data from the POS terminal, changes the bill according to the information provided and prints in step 12 the new bill, together with some personal information, on the associated printer after having checked the availability of the new amount via the standard processes. Moreover, the personalized information is displayed in step 13 on associated displays, too.

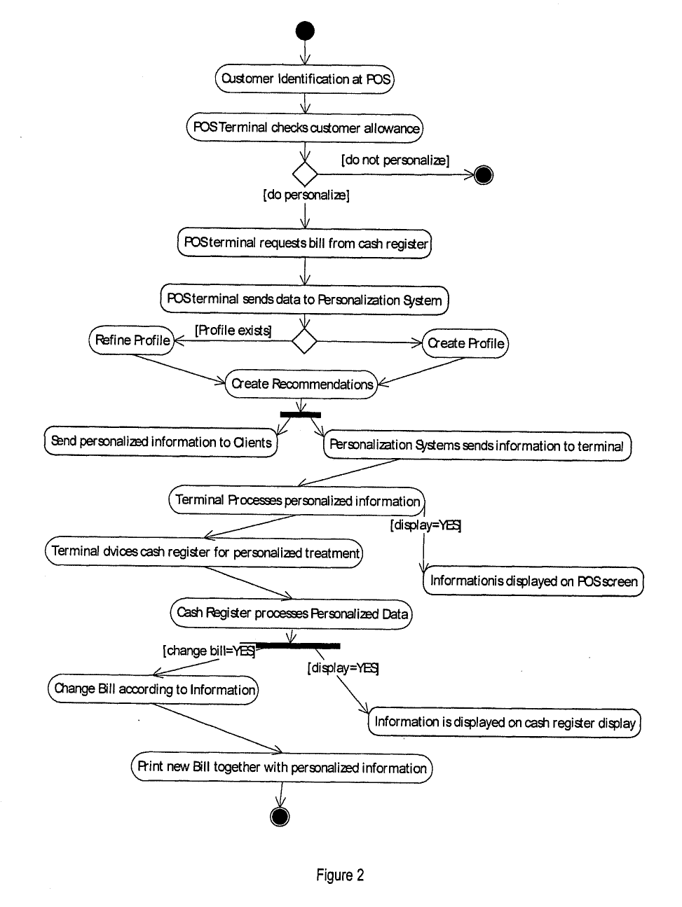

FIG. 2 shows the overall data flow.

Within the scope of the present invention, the system can be used to implement a pay-back service faster. It can also be used to combine the function of several pay-back cards within one card or to give over all pay-back functions chosen by a customer to his electronic cash card, credit card or analogous personal payment means. The method according to the present invention will be operated then as a bank service within the bank to fulfill all legal constraints.

Basically, a customer uses his/her payment card at a POS terminal (step 1). The identification system and the personalization system are run by a bank for servicing steps 2 and 5 to 9. Instead of personalized recommendations or general information pushed to the customer via client systems or display/printer of the cashier system, it now is a personalized redemption or pay-back information being transmitted to the customer. In both cases, however, it is information to the technical components involved.

The method according to the invention provides additional functionalities, so that

I. merchants can create specific offers or complex campaigns dedicated to their customers (e.g., “25% of all articles on May, 1., in all my branches”);
II. merchants get detailed reports about the impact/performance of their campaigns;
III. customers get the right offers due to personalization techniques in the right context (e.g., on his mobile device during shopping);
IV. customers can pick-up offers and will earn an redemption, when they make a purchase according the offer constraints
(e.g., buying some articles on May, 1., in one of the valid branches);
V. customers get detailed reports about their savings, activities, etc;
VI. banks can improve their knowledge about their customers (card holders) by accessing the personalization profiles.

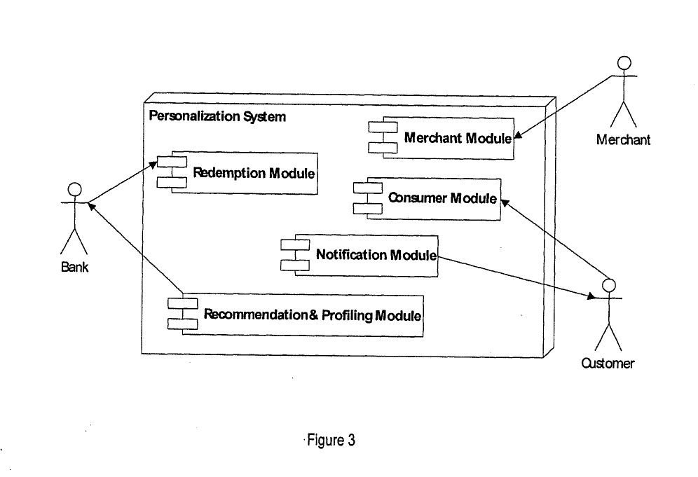

FIG. 3 shows major components used in the present invention. The merchant module offers functionality so that a merchant can (i) register for the service, (ii) maintain his basic data, (iii) create offers and campaigns and (iv) monitor the impact/performance of his campaigns.

The consumer module provides functionalities to the customer for (i) login and registration, (ii) basic data maintenance, (iii) viewing and picking-up recommended offers, (iv) viewing personal savings and activities. The Notification Module is responsible for pushing offers to the customers using channels such as SMS, e-Mail, etc.

The redemption module calculates the amount to be redeemed based on (i) a picked-up offer and (ii) a purchase record satisfying the constraints of the offer. These purchase records are provided by the bank and contain the following information:
User identification,
merchant identification on store level,
date and time of purchase,
amount and currency of purchase,
POS terminal identification.

Records, having this specific range of information are called Level 2 records/data (L2). No information concerning items bought is available in L2.

The task of the personalization module is to identify/filter those offers which (i) might be suitable to and (ii) are reachable (nearby) by a given user. The personalization is based on the purchase behavior (L2 records) and the customers interaction with the system (e.g. picking up offers, etc.) by applying artificial intelligence methods to this data.

At the very beginning, customers and merchants must register to the service provided. As the platform will be run as a bank service (similar to a net-banking application from the customer's view) the registration will be made by the bank for all customers who give their explicit ok (opt-in). On the other hand, merchants can register so that they will be contacted by the bank (or an authorized service) to sign a contract. Having signed a contract, the merchant can use the service. Merchant and customer data is stored in the system.

Being registered, a merchant can now create an offer which consists, of a marketing message, a picture, the award rule (e.g., 25% off) and some constraints (e.g., “Only on May, 1.”). The offer is stored in the database or personalization system, where it can be controlled by a compliance officer of the bank, if requested. The compliance manager is responsible, that the offer presentation fulfills all compliance/ethic rules of the bank (e.g., no pictures showing weapons wanted). This equals step 6 and 7 of FIG. 1.

In the next step (step 9) the offer is delivered to the right set of customers, based on their preference profiles constructed and refined by the personalization or recommendation engine. Offers can be delivered by using different channels such as WEB (e.g., net-banking), mobile devices, e-mail, SMS.

The customer, receiving the offer on his/her preferred device, sees the offer and can pick-it up if he/she is interested in. Only by picking-up an offer the user will get the pledged redemption after purchase. Picking-up an offer, as well as other system interactions, are stored within system for personalization issues.

Having picked-up an interesting offer, the customer walks to merchant's store and makes a purchase by using his payment card. The customer only will get a redemption, when he uses his card for the purchase. Note, this is a bank service, dedicated to their loyal customers.

All card based payments (L2 records) are sent regularly the merchant to the bank (e.g., each day).

The bank sends these L2 records to the platform where this information is used to (i) define valid redemptions and (ii) to refine/create user profiles for personalization.

Having calculated all redemptions, these payment instructions are sent back to the bank system to be processed. These redemption records contain the following information: (i) customer getting an redemption, (ii) merchant who pays the redemption, (iii) redemption amount, (iv) time.

Based on these redemption records, the bank can now transfer real money from the merchant's to the customer's account.

A surprising advantage of the method according to the present invention is that existing business processes—mainly the payment card based data flows—are used, thus reducing integration costs dramatically. Moreover, by not relying on the standard payment-card processes the following restrictions do not exist anymore:

A. No product information: Due to the fact, that only L2 data records are passed from the POS terminal to the bank and hence to the system implementing the method according to the present invention, we do not have any information concerning items/products bought. This is not only a limitation for the personalization system, but also for offer creation because product based offers such as “25% off on all Austrian Wines” cannot be processed/redeemed by the inventive system due to the missing bill information.

B. No immediate cash back: By relying on the standard payment card processes, POS terminal information (L2 records) is processed within a bank offline mostly at the end of day. Thus we cannot offer immediate cash back at the point of sales to the customer.

The present invention overcomes these limitations by extending and integrating the POS terminal together with its connected systems, e.g., cash register. By doing so, the platform implementing the inventive method will receive a detailed product list of the purchase together with the Level 2 data—called Level 3 data.

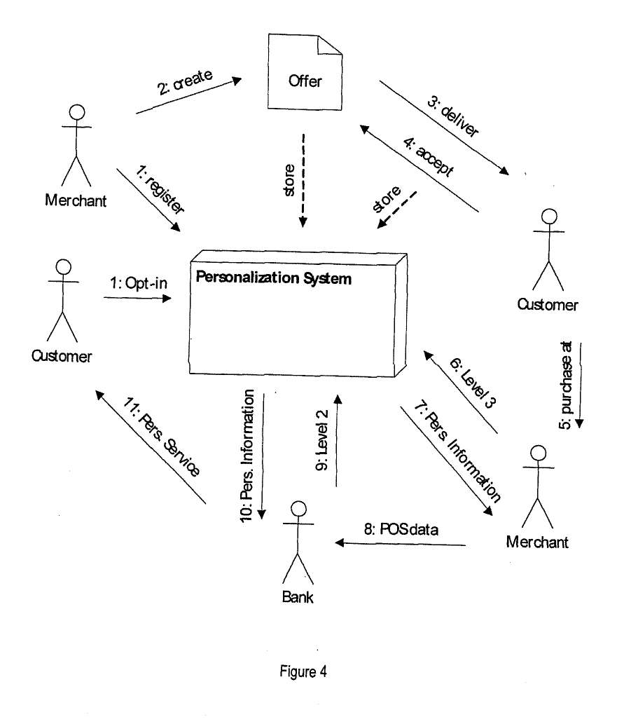

FIG. 4 shows again the overall process.

1. A method for providing a customer with information at a POS, comprising the steps of:
identifying the customer at a POS terminal;
requesting a bill from a cash register system and sending it together with the identification information to a personalization server;
creating and/or supplementing the customer's profile within the personalization server and calculating a personalized information based on the users history as well as provided data by the merchant;
sending back the personalized information to the POS terminal; and
putting out the personalized information to the customer via an interface.

2. The method according to claim 1, wherein the step of putting out the personalized information comprises a display connected with the POS terminal and/or connected with the cash register.

3. The method according to claim 1, wherein the step of putting out the personalized information uses SMS or e-mail service to a mobile communication system such as a mobile phone.

4. The method according to claim 1, wherein the step of putting out the personalized information is done via printing it on the bill of the cash register.

5. The method according to claim 1, wherein the user is identified at the POS terminal by a payment card or a mobile phone.

6. The method according to claim 1, wherein the method comprises the step of:
requesting an identification server if the customer's allowance for personalization its information exists.

7. The method according to claim 1, wherein the data for creating and/or supplementing the customers profile within the personalization server comprises one or more of: the customer identification, POS terminal identification, date, time, currency, the bill, descriptive information of the demanded products, descriptive information of the customer.

8. The method according to claim 1, wherein a recommendation engine creates personalized recommendation information based on the data provided.

9. The method according to claim 1, wherein the method comprises the step of: sending personalized recommendation information directly to the customers devices.

10. The method according to claim 1, wherein the method comprises the step of: displaying the personalized information on the display associated with the POS terminal according to the quality or existence of the recommendation.
